(19) United States
(12) Patent Application Publication
(10) Pub. No.: US 2026/0291636 A1
(43) Pub. Date: Sep. 24, 2026

(54) STATEFUL TRAFFIC TRACKING SYNCHRONIZATION IN NETWORK DEVICES

(71) Applicant: Hewlett Packard Enterprise Development LP, Spring, TX (US)

(72) Inventors: Marco Ney Rojas Jimenez, Heredia (CR); Alonso Jose Carvajal Rojas, Heredia (CR); Luis Alberto Garcia Gonzalez, Heredia (CR)

(21) Appl. No.: 19/088,079

(22) Filed: Mar. 24, 2025

(51) Int. Cl. H04J 3/06; H04L 7/04; H04L 49/101

(52) U.S. Cl. CPC H04J 3/0685; H04L 7/042; H04L 49/101

(57) ABSTRACT

In certain examples, a network switching system may include first switch circuitry and second switch circuitry, such that the first switch circuitry being distinct from the second switch circuitry, the second switch circuitry having a status data structure. The network switching system may include a hardware-level link coupling the first switch circuitry and the second switch circuitry. The network switching system may include a first processor associated with the first switch circuitry and configured to detect a new communication session at the first switch circuitry, generate a stateful synchronization message that includes state information about the new communication session, transmit the stateful synchronization message from the first switch circuitry to the second switch circuitry through the hardware-level link, and update the status data structure at the second switch circuitry based on the stateful synchronization message received from the first switch circuitry.

### BACKGROUND

Network devices are used in network infrastructures, providing the interconnection and communication between various devices and network segments. These network devices may include one or more network switches that direct data traffic between devices based on network protocols and configurations. Scalable and flexible switching solutions that may adapt to changing requirements while maintaining efficient management and operation may be appropriate as networks continue to grow in size and complexity.

### BRIEF DESCRIPTION OF THE DRAWINGS

For a more complete understanding of this disclosure, and advantages thereof, reference is now made to the following descriptions taken in conjunction with the accompanying drawings, in which:

FIG. 1 illustrates an example stateful traffic tracking synchronization system, according to some implementations;

FIG. 2A illustrates a network switching system of an example stateful traffic tracking synchronization system, according to some implementations;

FIG. 2B illustrates switch circuitries of an example stateful traffic tracking synchronization system, according to some implementations;

FIG. 3 illustrates an example data structure for a stateful traffic tracking synchronization system, according to some implementations;

FIG. 4 illustrates an example stateful traffic tracking synchronization method, according to some implementations;

FIG. 5 illustrates an example stateful traffic tracking synchronization method, according to some implementations;

FIG. 6 illustrates an example stateful traffic tracking synchronization method, according to some implementations; and

FIG. 7 illustrates an example stateful traffic tracking synchronization method, according to some implementations.

### DESCRIPTION

Switch virtualization technology may allow two or more physical switches to function as a single logical device at layer 2 while maintaining independent control planes at layer 3. One example of such technology is virtual switching extension (VSX). Switch virtualization may improve network performance, availability, and redundancy. For example, switch virtualization may allow for increased network resilience and load-balancing capabilities in enterprise and data center environments.

When implementing stateful traffic tracking across virtualized switches, synchronizing stateful information between the switches may be appropriate. Inconsistencies in traffic handling and potential security vulnerabilities may occur without such synchronization of stateful information. The synchronization may help maintain accurate flow states, provide proper firewall functionality, and provide a relatively seamless network traffic traversing the virtualized switches.

As network security objectives evolve, advanced features such as stateful firewalls and deep packet inspection may become appropriate for virtualized deployments. The stateful security features may use relatively precise synchronization of traffic flow information between virtualized switches to provide relatively consistent policy enforcement and seamless failover capabilities.

Certain implementations of this disclosure provide hardware-level synchronization of states between virtualized switches. By repurposing existing network infrastructure such as a hardware-level link (e.g., the keepalive link), certain implementations of the disclosed system allow high-speed, low-latency transmission of hardware-level synchronization messages. In some implementations, this approach uses capabilities of the switch hardware while reducing changes to the existing software architecture.

Certain implementations may involve configuring the hardware-level link (e.g., the keepalive link) to function as a stack link, effectively creating a hidden virtual switch framework underneath the virtualized topology. This configuration may transmit hardware-to-hardware messages, which include flow state information, protocol states, and/or other relevant data for maintaining synchronized stateful traffic tracking across the virtualized switches.

In some implementations, implementing stateful traffic tracking synchronization in a virtualized environment may involve configuring multiple interconnected components. In some implementations, a network switching system may include a logical network device formed by two or more of physical switches, where each physical switch includes one or more switch circuitries operating in a virtualized switch configuration, potentially with one or more switch circuitries of another physical switch. As an example, the first and second physical switch may include first switch circuitry and second switch circuitry, respectively. The first switch circuitry and the second switch circuitry may be distinct from each other, allowing for independent operation while functioning as a single logical unit.

As an example, the first switch circuitry may be implemented as a first virtualized switch and the second switch circuitry may be implemented as a second virtualized switch. The first and second virtualized switch circuitries may be physical switches that work together to provide improved network performance and redundancy. The first virtualized switch and the second virtualized switch may be communicatively coupled through multiple communication links to facilitate data transfer and synchronization.

In some implementations, the virtualized topology may include a data plane communication link between the first and second virtualized switch circuitries. As a particular example, this link may be an inter-switch link (ISL). The data plane communication link may couple the first virtualized switch and the second virtualized switch, serving as the primary path for data plane traffic between the first and second virtualized switches. The data plane communication link may be a high-bandwidth connection that allows for relatively seamless load balancing and failover capabilities, improving the overall reliability of the network.

In addition to the data plane communication link, the network switching system may include a hardware-level link (e.g., a so-called keepalive link) coupling the first virtualized switch and the second virtualized switch. In some implementations, the hardware-level link serves a dual purpose in the virtualized configuration. The hardware-level link may be used for exchanging heartbeat messages to monitor the operational status of each switch. In the context of stateful traffic tracking synchronization, the hardware-level link may be repurposed to, additionally or alternatively, transmit hardware-level synchronization messages between the first and second virtualized switches.

By implementing the synchronization mechanism at the hardware level, the network switching system may achieve improved performance and reduced latency compared to software-based solutions. In some implementations, this approach improves the scalability and reliability of virtualized deployments, such as in environments with high-throughput requirements or virtualized deployments that implement relatively advanced security features. Certain implementations of the disclosed network switching system and methods may allow network administrators to deploy relatively more sophisticated security policies and traffic management strategies across the virtualized switches, potentially without compromising on performance or introducing inconsistencies in traffic handling.

By operating at the hardware level, the network switching system may bypass software limitations and take advantage of certain processing component capabilities. This approach may provide precise, high-speed synchronization; reduced implementation risks, and reduced implementation costs.

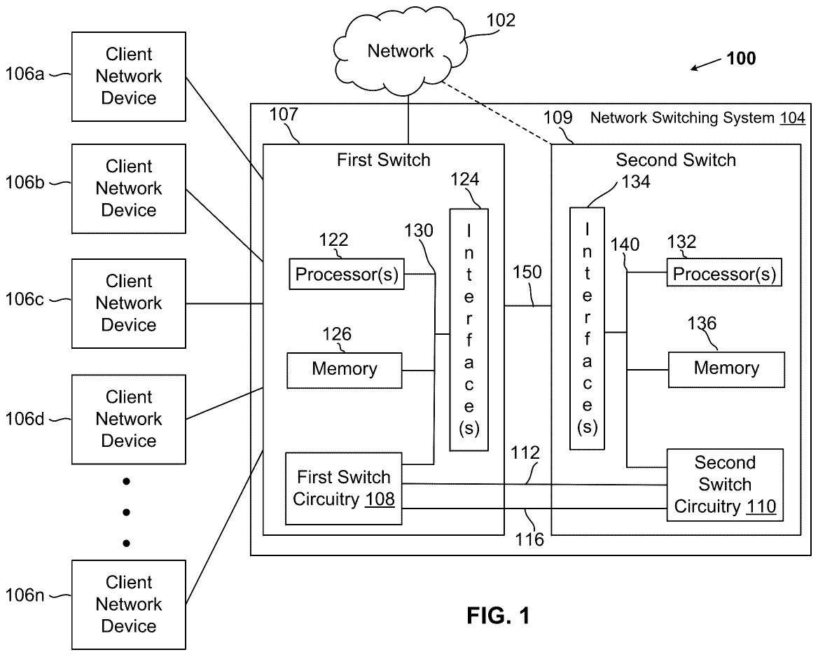

Turning to the figures, FIG. 1 illustrates an example computing system 100 for stateful traffic tracking synchronization, according to some implementations. The computing system 100 may include an external network 102, a network switching system 104, and multiple client network devices 106a-106n. The network switching system 104 may be coupled to the external network 102, which may represent a broader network infrastructure. This arrangement may allow the network switching system 104 to manage network traffic between the client network devices 106a-106n and the external network 102.

The computing system 100 may be implemented in one or more electronic devices and/or systems. Examples of electronic devices and systems may include a range of devices and/or systems that may be coupled to a network 102 or may interact with the network 102. The electronic devices may be broadly categorized into a network switching system 104, client devices 106, and other appropriate devices and/or systems. Although FIG. 1 shows the computing system 100 including a single network switching system 104, the computing system 100 may include any suitable number of the network devices 104. This disclosure also may refer to the network switching system 104 in the singular or the plural.

The network switching system 104 may be a processing system that may facilitate the transfer of data across the network 102. Examples of the network switching system 104 may include routers that direct data packets along the network 102, switches that couple multiple devices to the network 102 and manage data traffic, access points that provide wireless connectivity, firewalls that provide network security, and modems that couple networks 102 to the internet. Additionally, the network switching system 104 may be configured to perform a range of functionalities, including those typically associated with hosts and other devices and/or systems. For example, the network switching system 104 may be a multifunctional router that may operate as a server, hosting applications or services directly on the network switching system 104. In some implementations, the network switching system 104 may provide data routing, switching capabilities, and host network management software and tools. The network switching system 104 may perform one or more roles, thereby improving the efficiency and flexibility of network resource utilization. The network devices 104 may vary in terms of their data transfer speed, range of connectivity, security features, or the specific network protocols they support.

In some implementations, the network switching system 104 includes a first network switch 107 and a second network switch 109. The first network switch 107 and the second network switch 109 may be physical switches. In some implementations, the network switching system 104 may include a virtual switch (e.g., a virtual switching framework (VSF) member) that is implemented using the first network switch 107 and the second network switch 109. In some implementations, network switch 107 and network switch 109 include a first switch circuitry 108 and a second switch circuitry 110, respectively.

In some implementations, VSF technology virtualizes two or more physical devices into one virtual fabric which provides relatively high availability due to the reduction in recovery time and relatively simplified network design and management. VSF allows supported switches connected to each other through Ethernet connections (e.g., copper or fiber) to behave as a single chassis switch. The VSF technology allows network administrators to manage multiple physical switches as a single logical entity, reducing complexity and improving scalability in network deployments.

The switch circuitries 108 and 110 may be interconnected by a data plane communication link 112. In some implementations, the data plane communication link 112 allows for communication between the first switch circuitry 108 and the second switch circuitry 110, which may be considered communication “internal” to the virtual switch implemented by network switching system 104. In some implementations the data plane communication link 112 may transmit data plane traffic between the first switch circuitry 108 and the second switch circuitry 110.

Network switching system 104 (e.g., a virtual switch) may include a hardware-level link 116. In some implementations, a hardware-level link 116 (e.g., a keepalive link) is a dedicated communication channel between two physical switch circuitries 108 and 110. Initially designed to exchange heartbeat messages for monitoring the operational status of each switch circuitry 108 and 110, the hardware-level link 116 may be repurposed to facilitate hardware-level synchronization of stateful traffic tracking information. Operating at either layer 2 or layer 3 of the open systems interconnection (OSI) model, the hardware-level link 116 may allow high-speed, low-latency transmission of specialized synchronization messages that potentially might not be sent over standard data plane communication links 112 due to the unique metadata and protocol characteristics of the synchronization messages. The hardware-level link 116 may be implemented as a single connection or as part of a link aggregation group (LAG) for increased bandwidth and redundancy. By leveraging the hardware-level link 116 to provide state synchronization capabilities (and, if desired, the heartbeat functionality), the computing system 100 may potentially achieve efficient state consistency across both physical switch circuitries 108 and 110, potentially without requiring extensive modifications to the existing network infrastructure or software architecture.

The computing system 100 may be used to transmit network communication through a virtual port (such as one of virtual ports of a set of virtual ports), according to some implementations. In some implementations, the two switch circuitries 108 and 110 may be hidden and include a software component that represents two switch circuitries 108 and 110 as one virtual switch (e.g., one VSF member). In some implementations, the two switch circuitries 108 and 110 may each include application-specific integrated circuits (ASICs) or other processing components, that may be interconnected by the data plane communication link 112, e.g., a hidden stack link.

In addition to or instead of ASICs, the network switching system 104 may use various other processing components to manage network traffic and implement virtualized functionality. These processing components may include network processing units (NPUs), field-programmable gate arrays (FPGAs), general-purpose central processing units (CPUs), system-on-chip (SoC) solutions, multi-core processors, graphics processing units (GPUs), custom-designed chips, hybrid solutions combining different types of processors, and/or intelligent network interface cards (smart NICs). These processing components may be used individually or in combination (including with one or more ASICs), distributed across the chassis units to provide the performance, flexibility, and functionality appropriate for implementing virtualized and other networking features.

In some implementations, each processing component may include 24 ports associated with each switch circuitry 108 and 110. In some implementations, the customer sees 48 ports, all belonging to a single virtual switch. In some implementations, the architecture described herein allows the network switching system 104 to be presented to the customer (e.g., using the client devices 106) as a single virtual switch with 48 ports, while internally managing two separate 24-port processing components. It should be understood that the particular number of ports are provided as examples only, and this disclosure contemplates each ASIC (or other processing component) including any suitable number of ports.

In some implementations, the network switching system 104 may employ software-defined networking (SDN) protocols to manage routing of network traffic for the client network devices 106a-106n. This may provide a more granular control over traffic flows and quality of service, potentially improving the performance and user experience for the client network devices 106a-106n.

The scalability of the network switching system 104 may allow for a relatively seamless expansion to accommodate growth in the number of client network devices 106a-106n. As additional switches (which may include additional processing components) are added to the computing system 100, the network switching system 104 may automatically incorporate these new elements, maintaining a relatively consistent interface and level of service for the client network devices 106a-106n.

Examples of the client devices 106 include servers that host websites or applications, personal computers used by individuals or organizations, mobile devices such as smartphones and tablets, and Internet of Things (IoT) devices like smart home appliances, wearable devices, and connected vehicles. Additional examples of the client devices 106 include storage devices such as network attached storage devices or cloud storage servers, peripheral devices such as printers or scanners that may be accessed over the network 102, and specialized devices such as security cameras or environmental sensors that send data over the network 102. In some implementations, the client devices 106 may vary in terms of their processing power, storage capacity, operating system, the specific applications they run, data types they manage, or the specific network interfaces they use.

Multiple client devices 106 may be interconnected through the network switching system 104 that may be coupled to the network 102. A first client device 106a, a second client device 106b, a third client device 106c, and a fourth client device 106d may be shown as being coupled to the network switching system 104. Additionally, an Nth client device 106n is shown, indicating the network capability to communicatively couple to an unspecified number of client devices 106, thereby representing a scalable network system. The network switching system 104 may be communicatively coupled to the network 102, through which data exchange and communication between the network devices (e.g., the network switching system 104) may be performed. The computing system 100 may facilitate a dynamic communication network that may adapt to the varying demands of the coupled network switching system 104 and the data that the network switching system 104 transmits to and from the client devices 106 and the network 102.

The computing system 100 may be utilized in any data processing scenario, including stand-alone hardware, mobile applications, or combinations thereof. The computing system 100 may be used in a computing network, such as a public cloud network, a private cloud network, a hybrid cloud network, other forms of networks, or combinations thereof. As an example, the methods provided by the computing system 100 may be provided as a service over a network by, for example, a third party. The computing system 100 may be implemented on one or more hardware platforms, in which the modules in the system may be executed on one or more platforms. Such modules may run on various forms of cloud technologies and hybrid cloud technologies or be offered as a Software-as-a-Service that may be implemented on or off a cloud network. In some aspects, the network switching system 104 may be configured to manage network traffic in a variety of network environments, including but not limited to, local area networks (LANs), wide area networks (WANs), and cloud-based networks.

Each physical switch 107 and 109 in the virtualized pair (e.g., the network switching system 104) may include a main processor 122 and 132, and memory 126 and 136, respectively, which may manage overall switch operations. As an example, the first switch 107 may include a processor 122, an interface 124, and a memory 126. The processor 122 and interface 124 may be coupled to a connector 130 (which may be a communication pathway or a common bus). In some implementations, the memory 126 may be also coupled to the connector 130.

The first switch circuitry 108 may include a first set of physical ports. In some implementations, the second switch circuitry 110 may include a second set of physical ports. These physical ports may be used for coupling to other network devices or systems, facilitating the transfer of network traffic. In some implementations, the physical ports of the first switch circuitry 108 and the second switch circuitry 110 may be communicatively coupled to the set of virtual ports such that the physical ports are mapped to the set of virtual ports.

The processor 122 may be configured to control the operations of the first switch circuitry 108 and the second switch circuitry 110, managing the routing of network traffic and performing other network management tasks.

In some implementations, the memory 126 may be treated as a first storage and a second storage in various configurations of physical memory, i.e., within one or more memory devices. In some implementations, the second storage may store a program for execution by the one or more processors (e.g., the processor 122). The program may include instructions for managing the network switching system 104. The instructions may include instructions for mapping of a first set of physical ports of the network switching system 104 and a second set of physical ports of the network switching system 104 to a single set of virtual ports. The instructions may include instructions for presenting mapping of the first set of ports and the second set of ports as the single set of virtual ports.

In some aspects, the network switching system 104 may be configured to handle a variety of network traffic types, including unicast, multicast, broadcast traffic, and other suitable traffic types. The network switching system 104 may also support various network protocols, such as internet protocol (IP), transmission control protocol (TCP), and user datagram protocol (UDP), among others.

In some implementations, the network switching system 104, which may be a logical network device (e.g., a virtual switch implemented using physical switches 107 and 109), may be implemented through various configurations of the physical switches 107 and 109. For example, the first network switch 107 and the second network switch 109 may be standalone physical switches, integrated switches within a larger chassis, or physical switches configured to operate as a virtualized switch pair. In some implementations, two physical switches 107 and 109 together may form the logical network switching system 104. The specific implementation of the network switching system 104 may depend on the specific requirements of the network environment in which it may be deployed.

In some implementations, a connector 130 may be any suitable combination of buses and/or other types of wired or wireless connectors. In certain implementations, the connector 130 may include one or more buses, such as one or more PCI-Express buses.

In some implementations, the processor 122 may coordinate the operations of the various parts of the network switching system 104. As an example, the processor 122 may manage the routing of network traffic between the first switch circuitry 108 and the second switch circuitry 110 using SDN protocols. The network switching system 104 may utilize SDN protocols to manage routing of network traffic between the first switch circuitry 108 and the second switch circuitry 110.

In some aspects, the controller (e.g., the processor 122) may include programming instructions stored in the memory 126. These instructions may be executed by the processor 122 to perform various operations of the network switching system 104. For example, the programming instructions may include instructions for receiving a transmission on a first physical port of a combined set of physical ports of the network switching system 104. The instructions may include instructions for accessing a mapping to determine a first virtual port of a single set of virtual ports that corresponds to the first physical port. The instructions may include instructions for generating an indication of the first virtual port as a communication port for the transmission, where the indication of the first virtual port hides an identity of the first physical port.

In some implementations, the first storage and the second storage may be the same storage (e.g., the memory 126). This configuration may simplify the storage architecture of the network switching system 104, potentially reducing system complexity and improving efficiency. The use of a single storage unit for both the first and second storage may also facilitate faster data access and retrieval, potentially improving the performance of the network switching system 104.

In some implementations, the second physical switch 109 may include one or more processors 132, memory 136, and one or more interfaces 134, all of which may communicate using one or more communication links 140.

The processor 132 may be any component or collection of components adapted to perform computations and/or other processing-related tasks. The processor 132 can be, for example, a microprocessor, a microcontroller, a control circuit, a digital signal processor, an FPGA, an ASIC, an SoC, or combinations thereof. The processor 132 may include one or more processing cores. The processor 132 may include any suitable number of processors, or multiple processors may collectively form a single processor 132.

The memory 136 may include any suitable combination of volatile memory, non-volatile memory, and/or virtualizations thereof. For example, the memory 136 may include any suitable combination of magnetic media, optical media, RAM, ROM, removable media, and/or any other suitable memory device. The memory 136 may include data structures used to organize and store all or a portion of the stored data. The memory 136 may include a non-transitory computer-readable medium that stores programming for execution by one or more of the one or more processors 132.

The interfaces 134 represent any suitable computer element that can receive information from a communication link 150 and transmit information through the communication link 150, or both. The interfaces 134 represent any port or connection, real or virtual, including any suitable combination of hardware, firmware, and software, including protocol conversion and data processing capabilities, to communicate through a LAN, WAN, or other communication system that allows information to be exchanged. The interfaces 134 may facilitate wireless and/or wired communication. In certain implementations, at least one of the interfaces 134 is configured to communicate through a wired communication link 150 to the second physical switch 110.

The communication links 140 may include any suitable wired or wireless communication medium for the components of the second physical switch 110 to communicate with one another. For example, the communication links 140 may include any suitable combination of a bus or communication network.

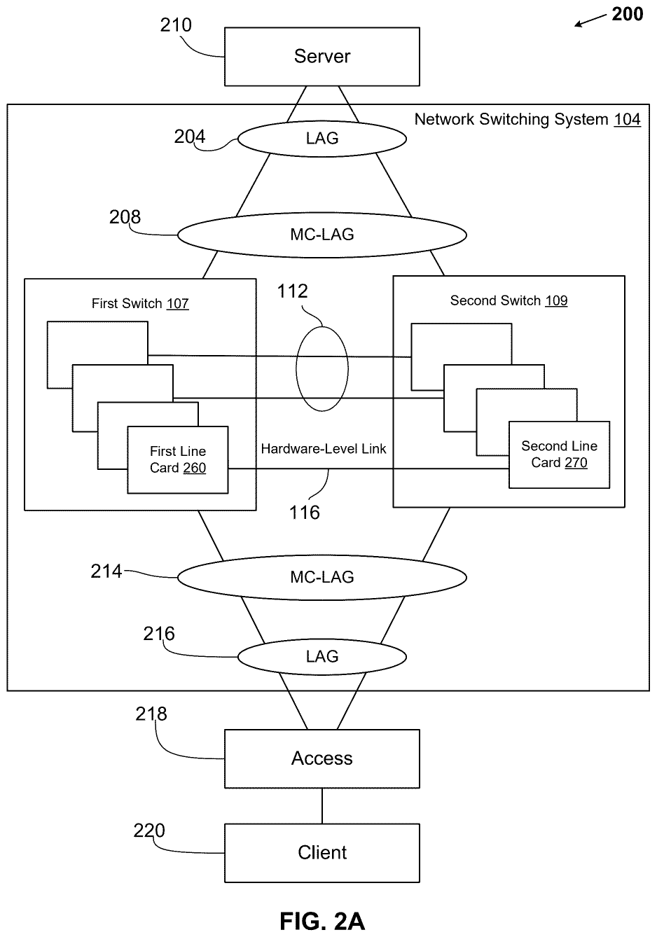

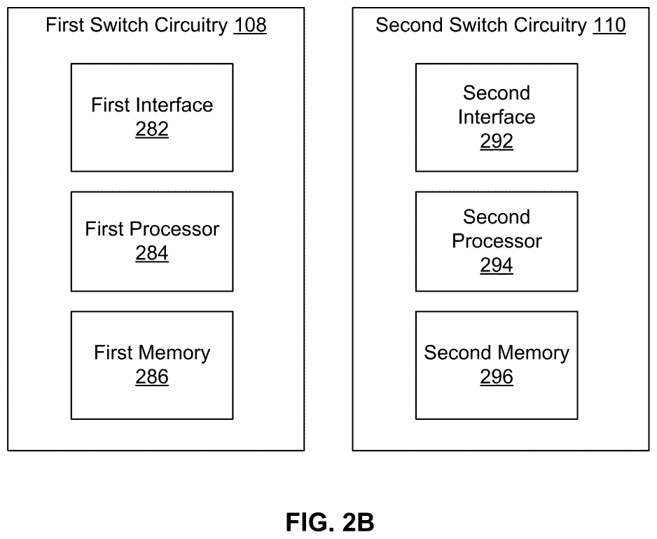

As discussed below, the individual first and second switch circuitries 108 and 110 (e.g., first and second line cards 260 and 270 illustrated in FIG. 2A within each switch 107 and 109) may have their own processing components (e.g., processors 284 and 294) and memory (e.g., 286 and 296), illustrated in FIG. 2B allowing for distributed processing capabilities across the virtualized switch pair.

FIG. 2A illustrates an example network switching system 104 of an example stateful traffic tracking synchronization system, according to some implementations. The network switching system 104 may include two chassis units, each including one node (where each node corresponds to, e.g., the line card 260 or 270). In some implementations, a node may refer to a processing and/or switching component within each physical chassis. As an example, each line card 260 and 270 may correspond to one of the physical switch circuitries 108 or 110 that form the virtualized switch pair.

The chassis may be the physical enclosure or framework that includes the switch components such as the switching fabric, line cards 260 and 270, and control modules. Each of these chassis units may represent a distinct physical entity within the network switching system 104. As an example, the first chassis unit may correspond to the first physical switch 107. The second chassis unit may correspond to the second physical switch 109. In some implementations, each chassis (first and second physical switch 107 and 109, respectively) may include its own node, e.g., line cards 260 and 270, which may have the switching and processing capabilities.

In the virtualized switch architecture, each node may represent a functional unit within a physical chassis. A node may include the switching fabric, control plane processing, and interface management capabilities of its respective physical switch 107 or 109. The first network switch 107 may correspond to the node in the first chassis, the second network switch 109 may correspond to the node in the second chassis. Together, these nodes may form the logical network switching system 104, allowing the network switching system 104 to function as a unified virtual switch while maintaining separate physical hardware.

The first and second physical switches 107 and 109 forming the virtualized pair may be implemented within the same chassis or in separate chassis, depending on the specific network requirements and hardware configuration. As an example, one or more physical switches 107 and 109 may be housed within a single chassis. In some implementations, each chassis may contain one or more line cards (e.g., 260 and 270, respectively), with each line card 260 or 270 contributing to the overall switching and processing capabilities of the physical switch 107 or 109.

FIG. 2B illustrates the switch circuitries 108 and 110 of an example stateful traffic tracking synchronization system, according to some implementations. In some implementations, the first switch circuitry 108 may include first interface 282 (e.g., ports of the first switch circuitry 108), a first processor 284, and first memory 286. In some implementations, the second switch circuitry 110 may include second interface 292 (e.g., ports of the second switch circuitry 110), a second processor 294, and second memory 296.

In some implementations, each physical switch circuitries 108 and 110 may include stateful instructions for monitoring, analyzing, and maintaining information about network traffic flows passing through the switches. The processor 284 or 294 and memory 286 or 296 in each physical switch circuitry 108 and 110 may execute these stateful instructions.

The stateful instructions, when executed by the processor 284 or 294, may allow the physical switch circuitry 108 and 110 to detect and track new communication sessions, maintain state information for active flows, analyze packet contents to determine flow characteristics; update flow states based on observed traffic patterns, and/or generate synchronization messages for state updates.

In some implementations, the processor 284 or 294 in each physical switch circuitry 108 and 110 may execute stateful instructions that manage the synchronization of state information between the two physical switch circuitries 108 and 110. These stateful instructions, when executed by the processor 284 or 294, may allow the physical switch circuitry 108 and 110 to generate hardware-level synchronization messages, transmit synchronization data over the hardware-level synchronization link 112, process incoming synchronization messages from the peer switch, update local state information based on received synchronization data, manage the prioritization of synchronization traffic, and/or handle failover scenarios and ensure state consistency.

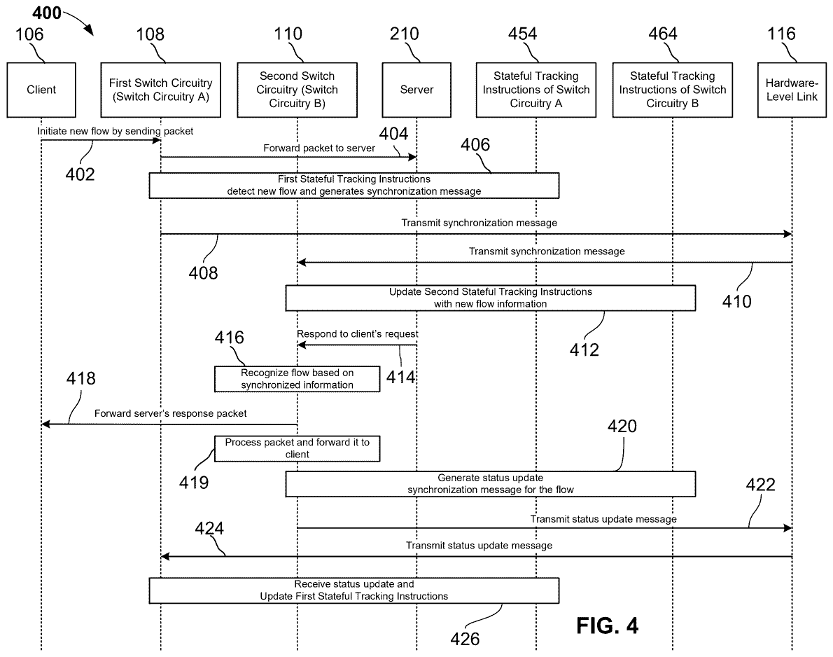

While the stateful tracking and synchronization functions may be implemented using hardware capabilities, they may be also implemented through software instructions executed by the switch processors 122 and 132 and/or switch circuitry processors 284 and 294. This software-based approach allows for greater flexibility and relatively streamlined updates compared to specialized hardware components. The stateful tracking instructions (e.g., 454 and 464 illustrated in FIG. 4), when executed by the switch processors 122 and 132 and/or switch circuitry processors 284 and 294, may allow the first and second switches 107 and 109 to detect and track new communication sessions, maintain state information, and/or generate synchronization messages as needed.

As an example, in the event of a failure in one of the physical switches (e.g., the first physical switch 107), the virtualized switch architecture allows a relatively seamless failover process. As illustrated by the dotted line in FIG. 1 transferring of data between the second physical switch 110 and the network 102 may be processed during the failover of the first physical switch 107. In some implementations, the hardware-level link 116 allows relatively rapid state synchronization between the first switch circuitry 108 and the second switch circuitry 110. This state synchronization allows important state information to be maintained and replicated across both the first and second physical switches 107 and 109. During a failover event, the functioning switch (e.g., the second physical switch 109) may continue network operations with relatively minimal disruption, using the synchronized state information to maintain consistent traffic handling and policy enforcement.

In some implementations, the first and second interfaces 282 and 292 may function and operate as the interfaces 124 and 134 illustrated in FIG. 1. In some implementations, the first and second memories 286 and 296 may function and operate as the memories 126 and 136.

In some implementations, the processors 284 and 294 may function and operate as the processor 122. By functioning similarly to processor 122, processors 284 and 294 allow distributed processing capabilities across the virtualized switch pair, allowing for efficient management of network operations and state synchronization.

A hardware synchronization module may be or included in the processor 122 (illustrated in FIG. 1), the first processor 284, and/or the second processor 294. The hardware synchronization module may assign a unique chassis identification (ID) to each of the first physical switch circuitry 108 and the second physical switch circuitry 110. This assignment may implement the creation of a hidden virtual switch framework (VSF) topology underlying the virtualized configuration. The unique chassis IDs may allow the hardware synchronization module to create a logical separation between the two switch circuitries 108 and 110 while maintaining their operation as a single virtual switch.

For example, the chassis units may be Chassis 0 and Chassis 1. The nodes within each chassis, specifically the node in Chassis 0 (corresponding to the first line card 260, corresponding the first switch circuitry 108) and the node in Chassis 1 (corresponding to the second line card 270 corresponding to the second switch circuitry 110), may be coupled by the data plane communication link 112 and the hardware-level link 116. These connections allow the nodes to function as a virtualized switch pair while maintaining their individual processing capabilities.

The data plane communication link 112 and the hardware-level link 116 may serve distinct purposes within the virtualized configuration. While the data plane communication link 112 may handle data plane traffic, the hardware-level link 116 may be dedicated to hardware-level synchronization messages. This separation allows for efficient management of different types of network traffic and control information.

In some implementations, sending the synchronization messages over the data plane communication link 112 (e.g., ISLs) might be problematic for one or more reasons. For example, the synchronization messages may include specific metadata that might not be compatible with standard network traffic. This metadata may be configured for direct ASIC-to-ASIC (or other processing component to processing component) communication, which data plane communication links 112 may not be configured to handle. As another example, in some implementations, the data plane communication links 112 may be primarily configured for regular client data traffic and standard control plane communication.

As another example, in some implementations, the metadata in the synchronization messages may alter the packet structure in a way that data plane communication links 112 may not be capable to process correctly. In some implementations, the specialized metadata use hardware-level recognition that data plane communication links 112, operating as typical network links, may not provide. In some implementations, sending the synchronization messages over data plane communication links 112 may lead to data corruption or misinterpretation of the synchronization information.

As another example, in some implementations, attempting to send the specialized traffic over data plane communication links 112 may negatively impact the performance of regular network traffic. In some implementations, the metadata of the synchronization messages may include sensitive state information that may be inappropriate to be mixed with regular traffic on data plane communication links 112.

As another example, in some implementations, the synchronization messages may use a proprietary protocol that may be incompatible with standard network protocols used on data plane communication links 112. Examples of such proprietary protocols may be a virtual switching extension (VSX) sync protocol, VSX state synchronization protocol, hardware accelerated replication protocol, stateful tracking exchange protocol, rapid consistency protocol, and/or low latency update protocol. In some implementations, the typical virtualized architecture may not support the transmission of the specialized synchronization messages over the data plane communication links 112.

In some implementations, VSX may refer to virtualization for aggregation switches or core switches to allow two physical switches 107 and 109 to function as a single logical device at layer 2 while maintaining independent control planes at layer 3. VSX may allow improved network performance, availability, and redundancy by allowing two switches 107 and 109 to work together as a unified network switching system 104. From a data-path perspective, each virtualized switch 107 or 109 may perform independent forwarding lookups to handle traffic, while some forwarding databases like media access control (MAC) and address resolution protocol (ARP) tables may be synchronized between the two devices 107 and 109 using a VSX control plane.

VSF may typically combine the control planes of two or more physical devices 107 and 109 into a single unified control plane, while VSX may maintain separate layer 3 control planes for each physical switch 107 and 109. In some implementations, VSX technology may allow two switches 107 and 109 to function as one logical device at layer 2 while maintaining separate layer 3 control planes. VSF may be more commonly used in access layer deployments, while VSX may be often utilized in aggregation or core layer implementations.

In some implementations, the hardware-level link 116 functions as a hardware-level link, facilitating the exchange of critical control information between the switches. In some cases, the hardware-level link 116 may operate at layer 2 or layer 3 of the OSI model, providing flexibility in the implementation of the synchronization mechanism.

In some implementations, layer 2 may be a data link layer. In some implementations, layer 2 may operate at the local network level. In some implementations, layer 2 may use media access control (MAC) addresses. In some implementations, layer 2 may be responsible for node-to-node data transfer within a local network segment. In some implementations, layer 2 may use the Ethernet and/or Wi-Fi protocols. In some implementations, layer 2 may encapsulate data from higher layers into frames by adding headers and trailers. In some implementations, layer 2 may not route traffic between different networks.

In some implementations, layer 3 may be a network layer. In some implementations, layer 3 may operates across different networks. In some implementations, layer 3 may use IP addresses. In some implementations, layer 3 may be responsible for routing data between different networks. In some implementations, layer 3 may use IP and ICMP protocols. In some implementations, layer 3 may encapsulate data from higher layers into packets by adding headers containing routing information. In some implementations, layer 3 may route traffic between different networks.

In some implementations, switch virtualization allows two physical switch circuitries 108 and 110 to function as a single logical device at layer 2. In some implementations, the switch circuitries 108 and 110 behave as one switch for local network traffic. While unified at layer 2, switch virtualization may maintain independent control planes at layer 3, allowing each switch circuitry 108 and 110 to make its own routing decisions.

In some cases, the hardware-level link 116 may be configured as a LAG for redundancy. This configuration may provide multiple physical connections between the first switch circuitry 108 and the switch circuitry 110, enhancing the reliability of the synchronization channel. The use of LAG may allow relatively continuous communication between the first and second switch circuitries 108 and 110 even if one of the physical links experiences a failure.

The bandwidth of the hardware-level link 116 may be increased from the standard 1 Gbps to support more connections per second. This bandwidth increase may allow for higher throughput of synchronization messages between the first switch circuitry 108 and the switch circuitry 110, allowing the network switching system 104 to handle more network traffic and maintain consistent state information across both first and second physical switch circuitries 108 and 110.

In some implementations, the data plane communication link 112 may serve as a data plane communication link 112 between the first switch circuitry 108 and the second switch circuitry 110 (which may include processing component 0 and processing component 1, respectively). The data plane communication link 112 may be directly coupled to both processing component 0 and processing component 1 within the network switching system 104 in a way that is not visible to the user. In some implementations, the link 112 may be encapsulated within hardware configuration of the network switching system 104. The data plane communication link 112 may provide sufficient bandwidth to move ingress traffic from the switch circuitries 108 and 110 to one another without losing or substantially without losing any packet information.

In some aspects, the data plane communication link 112 may function as a high-speed, relatively lossless communication channel between the nodes within each chassis. This capability may allow the network switching system 104 to handle high volumes of network traffic efficiently, potentially reducing latency and improving overall system performance.

The use of the data plane communication link 112 for internal communication may also improve the security of the network switching system 104 because the internal communication between the nodes may be hidden from external devices and systems. This concealment may provide an additional layer of protection against potential security threats.

In some implementations, the data plane communication link 112 allows the network switching system 104 to present itself as a single virtual switch while internally managing multiple switch circuitries 108 and 110, which may include processing component circuitries. When configuring virtualized tables for traffic routing, the network switching system 104 may use the data plane communication link 112 as a destination port for internal traffic between different chassis or nodes.

For example, in a multicast configuration, the virtualized table for one chassis may route all traffic to the other chassis through the data plane communication link 112, while another chassis may use a combination of the data plane communication link 112 and physical ports depending on the destination. The flexible routing capability may allow the network switching system 104 to efficiently manage complex network topologies while maintaining the appearance of a single, unified switch to external systems and users.

The data plane communication link 112 may also allow the scalability of the network switching system 104. As additional switches or processing components may be added to the system, the data plane communication link 112 may provide a consistent and high-performance method for inter-switch communication, allowing the system to grow without significantly increasing complexity or compromising performance. By leveraging the data plane communication link 112, the network switching system 104 may achieve a balance between the benefits of a distributed, multi-switch architecture and the relative straightforwardness of managing a single logical entity.

In some implementations, the network switching system 104 may include a first storage (which may be part of or the memory 126 illustrated in FIG. 1) that stores a mapping of virtual ports to at least one of the first set of ports in the first switch circuitry 108 or the second set of ports in the second switch circuitry 110. The mapping presents at least one of the first set of ports or the second set of ports as one set of virtual ports. This mapping may be used to translate between virtual ports and physical ports, allowing the network switching system 104 to manage network traffic in a flexible and efficient manner.

In some aspects, the network switching system 104 may include a software component (e.g., software) and an API. In some implementations, the software component interacts directly or indirectly with the API. The software may include a core logic for managing the virtualized functionality.

In some implementations, the network switching system 104 may present 48 ports (e.g., the set of virtual ports) to the customer while internally managing two 24-port processing components (e.g., two or more sets of physical ports). This configuration may allow for greater flexibility in hardware design and cost optimization. As an example, the first switch circuitry 108 may include one 24-port processing component (e.g., processing component 0), while the second switch circuitry 110 may include another 24-port processing component (e.g., processing component 1). The controller may manage the processing component 0 and the processing component 1 in a way that presents them as a single 48-port switch to external systems and users.

The data plane communication link 112 between the first switch circuitry 108 and the second switch circuitry 110 may facilitate high-speed communication between the two processing components. Such internal communication may allow the network switching system 104 to efficiently manage traffic across all 48 ports, potentially improving overall performance and reducing latency of the network switching system 104.

In some implementations, the network switching system 104 may use the unified chassis identifier and node identifier in conjunction with the virtual port mapping stored in the first storage. Such combination may allow the network switching system 104 to accurately route traffic between the virtual ports presented to the customer and the physical ports on the two 24-port processing components. The controller may use this information to manage traffic flow, load balancing, and failover scenarios, potentially improving the reliability and performance of the network switching system 104.

In some implementations, the network switching system 104 may be expanded to incorporate additional network switches. For instance, a third network switch may be added to the network switching system 104, including a third set of physical ports. The mapping stored in the first storage may be updated to incorporate the third set of physical ports into the set of virtual ports. This expansion may allow the system to scale up its network capacity while maintaining the unified virtual switch presentation to the customer. The addition of the third network switch may be managed by the API, which may receive a configuration request to modify the mapping and update the mapping according to the received configuration request. This approach may allow for dynamic expansion of the network switching system 104, potentially improving its scalability and flexibility. Even though adding only the third network switch is described, any number of network switches may be added, such as a fourth network switch, a fifth network switch, etc.

When scaling to support more than two processing components or switches, the virtualized tables may need to be expanded accordingly. For each additional switch (that may include a processing component) added to the topology, new entries may be appropriate in the virtualized tables of all existing switches to maintain proper routing paths. This expansion of virtualized tables may allow the network switching system 104 to manage traffic routing across a larger number of physical switches while still presenting a unified interface to external management systems and users.

The data plane communication link 112 may provide scaling of the network switching system 104. As additional switches or processing components may be added, the data plane communication link 112 may provide a relatively consistent and high-performance technique for inter-switch communication. This may allow the network switching system 104 to grow without substantially increasing complexity or compromising performance.

The virtualized configuration within the network switching system 104 may allow implementation of such networking features as stateful traffic tracking and related security functionalities. By maintaining synchronized state information across the first switch circuitry 108 and the switch circuitry 110, the network switching system 104 may allow relatively consistent application of security policies and prevent potential vulnerabilities that could arise from inconsistent state information across the network switching system 104.

The network architecture for implementing hardware-level synchronization between switches may include a LAG interface 204 connecting the network switching system 104 to the server 210. In some implementations, the network switching system 104 connects through a LAG interface 216 to an access network 218, which in turn connects to a client device 106.

The hardware-level link 116 may be a dedicated connection, e.g., a specific link between the two switches in a virtualized pair, e.g., the first and second switch circuitries 108 and 110. In some implementations, the hardware-level link 116 may be primarily configured for exchanging heartbeat messages to verify that the partner switch is operational. In some implementations, the hardware-level link 116 may be repurposed to carry hardware synchronization messages. In some implementations, the hardware-level link 116 may be distinct from the data plane communication link 112 (which may be the data plane communication link 112), which is used for regular data traffic.

Typically, a 1 Gbps connection, the hardware-level link 116 may be sufficient for control traffic but may be not designed for high-volume data transfer. In some implementations, the hardware-level link 116 may allow maintaining awareness of the partner switch's status in the virtualized topology.

In some implementations, the hardware-level link 116 may become mandatory when implementing the stateful synchronization feature of the single virtual switch. In some implementations, the hardware-level link 116 may provide hardware-level communication and used to transmit processing component-level messages between the first and second switch circuitries 108 and 110. In some implementations, the hardware-level link 116 may provide a dedicated path for control and synchronization traffic, separate from customer data.

In some cases, one or more hardware synchronization modules (e.g., first and second modules or processors 284 and 294) may be configured to repurpose the hardware-level link 116 as a stack link. This repurposing may allow for the transmission of hardware-level synchronization messages between the first physical switch circuitry 108 and the second physical switch circuitry 110.

As an example, the stack link may be a dedicated high-speed link used to connect the first and second switch circuitries 108 and 110 in a stack configuration. The stack link may provide direct hardware-level communication between switch processing components. The stack link may be configured for rapid exchange of control and state information between the first and second switch circuitries 108 and 110.

The stack link may allow transmission of packets with special metadata headers that only processing components may interpret and process. The stack link may allow creation of a single control plane across multiple physical switches (e.g., the first and second switch circuitries 108 and 110). In some implementations, the stack link may facilitate automatic hardware-level state synchronization between connected switches. The stack link may use vendor-specific protocols for inter-switch communication.

The stack link may provide higher bandwidth than standard typical network links for inter-switch traffic. In some implementations, when the hardware-level link 116 is the stack link in a virtualized topology, it allows to carry hardware synchronization messages. By repurposing the hardware-level link 116 to function similar to a stack link, the physical switch circuitries 108 and 110 may benefit from the hardware-level synchronization capabilities typically found in stacked switch configurations, without actually implementing a full stacking solution.

Repurposing the hardware-level link 116 as a stack link may functionally transform the hardware-level link 116 from its original purpose to serve as a stack link. The repurposing may allow the hardware-level link 116 to carry hardware-level synchronization messages, similar to how links function in the virtualized topology.

Utilizing the front-plane stacking features of the processing component, applying them to a virtualized setup, the repurposing of the hardware-level link 116 as the stack link may leverage virtualized capabilities. In some implementations, the repurposing of the hardware-level link 116 as the stack link may allow the processing components of both virtualized switches to communicate directly, bypassing higher software layers.

In some implementations, the repurposing of the hardware-level link 116 as the stack link may allow high-speed, low-latency exchange of stateful information between the first and second switch circuitries 108 and 110. In some implementations, the repurposing of the hardware-level link 116 as the stack link may allow hardware-level synchronization without major modifications to the existing virtualized architecture. In some implementations, the repurposing of the hardware-level link 116 as the stack link may provide a dual-purpose link, e.g., by maintaining the original keepalive functionality while adding the new synchronization capability.

In some implementations, the repurposing of the hardware-level link 116 as the stack link may allow operating the stack-like functionality beneath the OS level, relatively invisible to normal switch operations. Utilizing an existing, dedicated link for synchronization instead of burdening the data plane communication link 112 or requiring new connections may improve performance of the single virtual switch. In some implementations, the repurposing of the hardware-level link 116 as the stack link may allow implementation of stateful features such as firewalls relatively consistently across virtualized pairs.

In some implementations, if the hardware-level link 116 is not repurposed as the stack link, it may cause software refactoring, e.g., code restructuring, architectural changes, complexity reduction to simplify the code structure to improve readability and maintainability, performance improvement, relatively substantial time and effort to implement changes across multiple software components, introduce new bugs or issues (especially in complex systems), project scope increase, increased time to market, and/or OS-level changes.

In some implementations, the repurposing of the hardware-level link 116 as the stack link may allow the implementation of hardware-level stateful synchronization in virtualized topologies without extensive software refactoring or hardware changes. The hardware-level link 116 may allow efficient, high-speed stateful synchronization between the physical switch circuitries 108 and 110, extending its functionality beyond checking status of the partner switch.

By configuring the hardware-level link 116 to function as a stack link, the system may facilitate the transmission of hardware-level synchronization messages between the first physical switch circuitry 108 and the second physical switch circuitry 110. This repurposing of the hardware-level link 116 may implement efficient synchronization of stateful traffic tracking instructions across the physical switch circuitries 108 and 110 without requiring significant changes to the underlying network architecture.

The hardware synchronization module may use a new processing component application programming interface (API), e.g., called “pv_vsx,” to create a stacking topology underneath the virtualized configuration.

When performing synchronization operations, the hardware may use a unique replication (REP) entry with hardcoded multicast index (e.g., called “mcast_idx”) and virtual local area networks (VLANs). This specialized REP entry may facilitate the targeted distribution of synchronization messages between the first physical switch circuitry 108 and the second physical switch circuitry 110, ensuring that state information is efficiently propagated across the network switching system 104.

The network switching system 104 may include a hidden virtualized topology that facilitates the hardware-level synchronization. The LAG interfaces 204 and 216 implement load balancing and redundancy for traffic flowing between the connector 130 and client device 106 through the network switching system 104.

In some implementations, the LAG may be implemented by combining multiple physical network links into a single logical link. In some implementations, the LAG increases bandwidth and provides redundancy. In some implementations, the LAG may be implemented on a single switch. In some implementations, the LAG follows IEEE 802.3ad standard. In some implementations, the LAG distributes traffic across multiple links for load balancing.

In some implementations, if one link fails, traffic may still flow through other links of the LAG. In some implementations, the LAG combines bandwidth of multiple links. In some implementations, the LAG appears as one interface to upper layer protocols. In some implementations, the LAG may be used to connect switches or servers to switches. In some implementations, the LAG may be compatible configuration on both ends of the link.

In some implementations, a multi-chassis link aggregation group (MC-LAG) may be an extension of LAG that spans multiple chassis (or switches). In some implementations, MC-LAGs 208 and 214 provide redundancy and load balancing across separate physical switches, e.g., switch circuitries 108 and 110. In some implementations, the MC-LAGs 208 and 214 may involve two or more switch circuitries 108 and 110 acting as one logical switch.

In some implementations, the MC-LAGs 208 and 214 offer greater fault tolerance than standard LAG. In some implementations, the MC-LAGs 208 and 214 may actively forward traffic substantially simultaneously between both switch circuitries 108 and 110. In some implementations, for implementing the MC-LAGs 208 and 214, state synchronization between participating switches, e.g., switch circuitries 108 and 110, may be appropriate. In some implementations, the MC-LAGs 208 and 214 use proprietary protocols for inter-switch communication.

This architecture allows for stateful traffic tracking synchronization between the first physical switch circuitry 108 and the second physical switch circuitry 110 while maintaining normal virtualized operations through the data plane communication link 112.

The stateful synchronization may be a process of keeping the stateful tracking instructions in both virtualized switches relatively consistently updated with the latest information about network flows, allowing security policies and traffic handling to remain consistent regardless of which switch circuitry 108 and 110 processes a given packet.

In some implementations, the stateful synchronization may provide state information, e.g., by maintaining and sharing information about the current state of network connections or traffic flows. In some implementations, the stateful synchronization may provide real-time or near real-time exchange of state data between the first and second switch circuitries 108 and 110.

In some implementations, the stateful synchronization may allow all participating devices to have the same up-to-date information about network states. In some implementations, the stateful synchronization may allow preserving the context of network traffic across multiple devices. In some implementations, the stateful synchronization may track state information for various protocols such as TCP, UDP, internet control message protocol (ICMP), and quick UDP internet connections (QUIC).

In some implementations, the stateful synchronization may allow implementation of stateful security features such as firewalls across multiple devices. In some implementations, the stateful synchronization may allow keeping track of established connections, their progress, and their current status. In some implementations, the stateful synchronization may allow dynamic updates by continuously updating state information as network conditions and traffic patterns change. In some implementations, the stateful synchronization may allow implementation of a relatively consistent behavior across distributed network devices, like the virtualized pair in this invention.

The use of unique chassis IDs and specialized REP entries may allow the network switching system 104 to maintain a clear distinction between normal network traffic and synchronization traffic. This separation may implement more efficient routing of synchronization messages through the hardware-level link 116 repurposed as a stack link, while minimizing interference with regular data plane operations occurring through the data plane communication link 112.

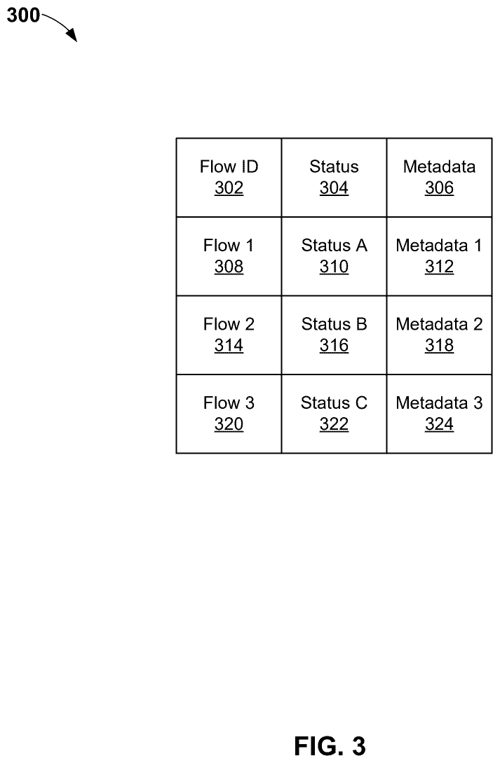

FIG. 3 illustrates an example data structure 300 for a stateful traffic tracking synchronization system, according to some implementations. The data structure 300 may represent status information maintained by a switch in the network device. The data structure 300 includes multiple columns and rows, configured to store and organize data for stateful traffic tracking and synchronization between switches.

In some implementations, the data structure 300 includes three columns: Flow ID column 302, Status column 304, and Metadata column 306. The Flow ID column 302 may include unique identifiers for each network flow being tracked (e.g., Flows 1, 2, and 3 in cells 308, 314, and 320, respectively). This allows the switch to efficiently reference and update information for specific communication sessions.

The Status column 304 may store the current state (e.g. Status A, B, and C in cells 310, 316, and 322, respectively) of each Flow 1, 2, and 3 in cells 308, 314, and 320, respectively. In some cases, this may include protocol-specific states such as “SYN SENT,” “ESTABLISHED,” or “FIN WAIT” for TCP connections. As an example, “SYN SENT” indicates a TCP connection state where the client has sent a SYN (synchronize) packet to initiate a connection with the server, but has not yet received a SYN-ACK (synchronize-acknowledge) response. In some implementations, this state indicates that the connection attempt is in progress.

In some implementations, the “ESTABLISHED” state is a TCP connection state where both the client and server have completed the three-way handshake. In this state, the connection is fully open and data may be exchanged between the two endpoints.

In some implementations, the “FIN WAIT” state may be a TCP connection state that occurs when one endpoint has sent a FIN (finish) packet to initiate the connection termination process, but is still waiting for an acknowledgment and the other endpoint's FIN packet. This state may be further divided into FIN-WAIT-1 and FIN-WAIT-2, depending on whether the initial FIN has been acknowledged. For other protocols such as UDP, ICMP, or QUIC, appropriate status indicators may be used to reflect the current state of the communication session.

The Metadata column 306 may include additional information (e.g., Metadata 1, 2, and 3 in cells 312, 318, and 324, respectively) relevant to each Flow 1, 2, and 3 in cells 308, 314, and 320, respectively. Metadata 1, 2, and 3 in cells 312, 318, and 324, respectively, may include various types of data such as source and destination IP addresses, source and destination port numbers for TCP or UDP connections, protocol identifiers, and other details about the communication session.

In some cases, the data structure 300 may store flow packet information and protocol state information for stateful traffic tracking. This information may allow the network switching system 104 to maintain comprehensive records of ongoing network communications and their current states.

The status information data structure 300 may allow maintenance of synchronized state information between the first and second switch circuitries 108 and 110 in the network switching system 104. When a new communication session is detected or an existing session's state changes, the first switch circuitry 108 may update its local data structure 300 and generate a hardware-level synchronization message to be sent to other switches (e.g., to the second switch circuitry 110).

In some cases, these hardware-level synchronization messages may include the information stored in the status table, such as the Flow ID, current Status, and relevant Metadata. This may allow receiving switches to update their own status tables, ensuring consistent stateful information across the network device.

The data structure 300 may support tracking and analyzing stateful information for various protocols, including TCP, UDP, ICMP, and QUIC. By maintaining detailed records for each of these protocols, the network device may provide relatively comprehensive stateful traffic tracking capabilities.

The synchronization process between the first and second processors 284 and 294 may involve the exchange of specialized messages. These messages may include a stack header to facilitate routing within the virtualized topology, a metadata layer including relevant state information, and a portion of the original packet data.

In some cases, the state information stored in the data structure 300 and transmitted in synchronization messages may comprise one or more of the following: source IP address, destination IP address, source TCP port, source UDP port, destination TCP port, destination UDP port, an identifier of the new communication session, or a protocol state. This relatively granular level of detail may implement precise tracking and synchronization of network flows across switches.

To provide context for synchronization, the hardware-level synchronization messages generated based on this data structure 300 may include up to 256 bytes of the original packet data. This additional information may help receiving switches accurately reconstruct the network flow and apply appropriate security policies or traffic management rules.

By maintaining and synchronizing this status information data structure 300 across the switch circuitries 108 and 110, the network switching system 104 may achieve relatively consistent stateful traffic tracking and allow various features such as stateful firewalls and deep packet inspection across the entire virtual switch framework.

In some implementations, the stateful firewall tracks the state of network connections passing through it, allowing or blocking traffic based on the context of the connection rather than just individual packets. By synchronizing state information between the first and second switch circuitry 108 and 110, respectively, the firewall may maintain consistent behavior across both switches.

In some implementations, the firewall keeps track of the state of each connection, including information such as: source and destination IP addresses, source and destination ports, a protocol (TCP, UDP, etc.), a connection state (e.g., SYN sent, SYN-ACK received, ESTABLISHED), and/or sequence numbers for TCP connections.

In some implementations, when a new connection is established or an existing connection's state changes on the first switch circuitry, it generates a stateful synchronization message. This message may be transmitted to the second switch circuitry through the hardware-level link (keepalive link). The second switch circuitry then updates its status table with this information.

In some implementations, by maintaining synchronized state information, both switch circuits may apply the same firewall rules consistently. For example, if a connection is allowed by the first switch circuitry, the second switch circuitry will also allow packets belonging to that connection, even if it didn't see the initial connection establishment.

In some implementations, in scenarios where incoming and outgoing traffic for a single connection might pass through different switches (asymmetric routing), the synchronized state information allows that both switches have the necessary context to properly handle the traffic.

In some implementations, if one switch fails, the other switch has up-to-date state information, allowing it to continue enforcing firewall policies without interruption or loss of connection tracking. In some implementations, with synchronized state information, the firewall may implement the following security features across both switches: TCP sequence number verification, protection against spoofing and session hijacking attempts, and/or application-layer protocol inspection.

By performing state synchronization at the hardware level, the firewall may maintain high-speed packet processing while still providing stateful inspection across multiple switches.

FIG. 4 illustrates an example stateful traffic tracking synchronization method 400, according to some implementations. The method 400 may be a synchronization process for stateful traffic tracking, according to some implementations. The synchronization process may involve the first physical switch circuitry 108 (e.g., Switch Circuitry A), the second physical switch circuitry 110 (e.g., Switch Circuitry B), and the hardware-level link 116.

The process begins with a step 402, where the client device 106 may initiate a new communication session by sending a packet to the first physical switch circuitry 108. In a step 404, the first physical switch circuitry 108 forwards the packet to server 210.

At a step 406, stateful tracking instructions 454 of the first physical switch circuitry 108 may detect the new communication session and triggers a learn event. This detection may be performed by a first processor 284 associated with the first physical switch circuitry 108. The first processor 284 may be configured to detect new communication sessions at the first physical switch circuitry 108.

Following the detection, in a step 408, the first physical switch circuitry 108 may generate a stateful synchronization message including state information about the new communication session. This message may include details such as source and destination IP addresses, port numbers, protocol identifiers, and the current state of the communication session.

The process continues with a step 410, where the first physical switch circuitry 108 may transmit the synchronization message to the second physical switch circuitry 110 through the hardware-level link 116. The hardware-level link 116 may be configured to transmit both heartbeat messages and hardware-level synchronization messages. In some cases, the first processor 284 may prioritize the transmission of heartbeat messages over the stateful synchronization messages through the hardware-level link 116.

In a step 412, the second physical switch circuitry 110 may receive the synchronization message and updates its local stateful tracking instructions 464. This update may involve modifying a status data structure within the second physical switch circuitry 110 based on the received stateful synchronization message.

In some implementations, the stateful tracking and synchronization instructions 454 and 464 may be stored in the main memory 126 and 136 of each physical switch 107 and 109, respectively, in the memory of individual line cards, e.g., the first and second memories 286 and 296 of the first and second switch circuitries 108 and 110, or distributed across any of these memories. The relatively flexible storage approach may allow for efficient execution of these functions at various levels of the switch architecture.

The stateful tracking instructions 454 and 464 may be executed by the main processor 122 and 132 of each switch 107 and 109, by the processors 284 and 294 on individual line cards (e.g., the first and second switch circuitries 108 and 110), or by a combination of any of the above. This distribution of processing allows for relatively efficient handling of stateful operations and synchronization tasks across the virtualized switch architecture.

At a step 414, the connector 130 responds to the client device's 106 request. A step 416 shows the stateful tracking instructions 454 of the second physical switch circuitry 110 recognizing the flow based on the synchronized information. In a step 418, due to load balancing, the return packet may be routed through the second physical switch circuitry 110.

At a step 419, the second physical switch circuitry 110 may process the packet and forwards it to the client device 106. This processing may be performed by a second processor 294 associated with the second physical switch circuitry 110. The second processor 294 may determine that the packet relates to the new communication session based on the updated status data structure and process it accordingly.

At a step 420, the second physical switch circuitry 110 may generate an update synchronization message for the flow state. In steps 422 and 424, the second physical switch circuitry 110 sends this update message through the hardware-level link 116 to the first physical switch circuitry 108.

At a step 426, the first physical switch circuitry 108 receives the update and refreshes its local flow state information. The step 426 may involve resolving any conflicts between the state information in the first physical switch circuitry 108 and the second physical switch circuitry 110 by overwriting the state information in the first physical switch circuitry 108 with the updated information from the second physical switch circuitry 110.

In some cases, a spare filter may be implemented to prevent redundant packet transmission between the first physical switch circuitry 108 and the second physical switch circuitry 110. This filter may identify and block duplicate packets before transmission, improving network efficiency.

In some implementations, a hardware-to-hardware message filter may be used to specify which components require state synchronization. This filter may analyze message content and destination to determine which hardware components need to be updated when a state change occurs.

The synchronization process may also include methods to handle potential failures. For example, if the hardware-level link 116 fails, the hardware synchronization module may be configured to reroute synchronization traffic through alternative paths, such as other hardware-level links or other available connections between the switch circuitries 108 and 110. As an example, multiple hardware-level links may be distributed across different line cards. This configuration allows improved reliability by providing redundancy and may increase the bandwidth available for synchronization traffic in the virtualized setup.

By implementing this synchronization process, the network switching system 104 may maintain consistent stateful information across both physical switches, allowing advanced features such as stateful firewalls and ensuring proper handling of network traffic in the virtualized environment.

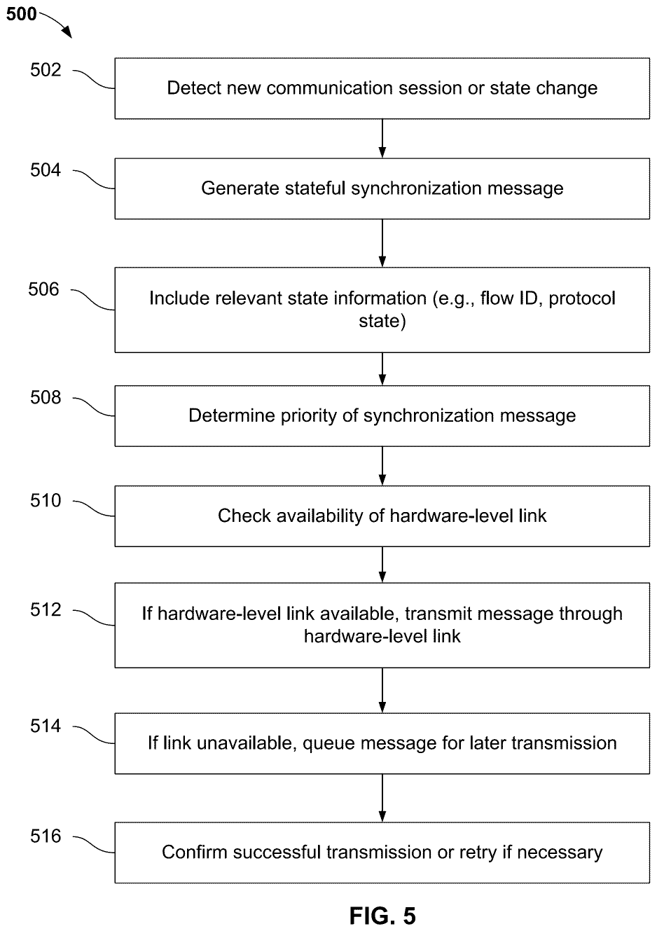

FIG. 5 illustrates an example stateful traffic tracking synchronization method 500, according to some implementations. The method 500 may detect and synchronize state changes in a computing system 100. The method 500 may include message generation, link availability verification, transmission handling, and confirmation steps. The method 500 may include alternative paths based on link availability and verification of successful transmission, enhancing the reliability of the synchronization mechanism in the virtualized environment described in previous figures.

The method 500 begins at step 502, where a new communication session or state change is detected in one of the physical switch circuitries, which may correspond to the first physical switch circuitry 108 or second physical switch circuitry 110 from FIG. 1.

The method 500 continues to step 504, where a stateful synchronization message is generated, similar to the process described in step 408 of FIG. 4. At step 506, relevant state information is included in the message, such as flow ID and protocol state, which may be stored in the status data structure introduced in FIG. 4.

The method 500 then continues to step 508, where the priority of the synchronization message is determined. The step 508 may involve the processor 122 from FIG. 1 and/or first and second processors 284 and 294 from FIG. 2 making decisions based on the current network conditions. Following this, at step 510, the processor 122 and/or first and second processors 284 and 294 check the availability of a hardware-level link, which may correspond to the hardware-level link 116 shown in FIGS. 1 and 2.

At step 512, if the hardware-level link is available, the message is transmitted through this link, similar to the method 400 described in step 410 of FIG. 4. Alternatively, at step 514, if the link is unavailable, the message is queued for later transmission, using the memory 126 from FIG. 1 for temporary storage.

The method 500 continues at step 516, where the first or second physical switch circuitry 108 or 110 confirms successful transmission or initiates a retry if necessary. This step may involve communication between the switch circuitries 108 and 110 illustrated in FIG. 4. In some implementations, the state information is maintained in the data structure 300, which may be implemented within the memory 126.

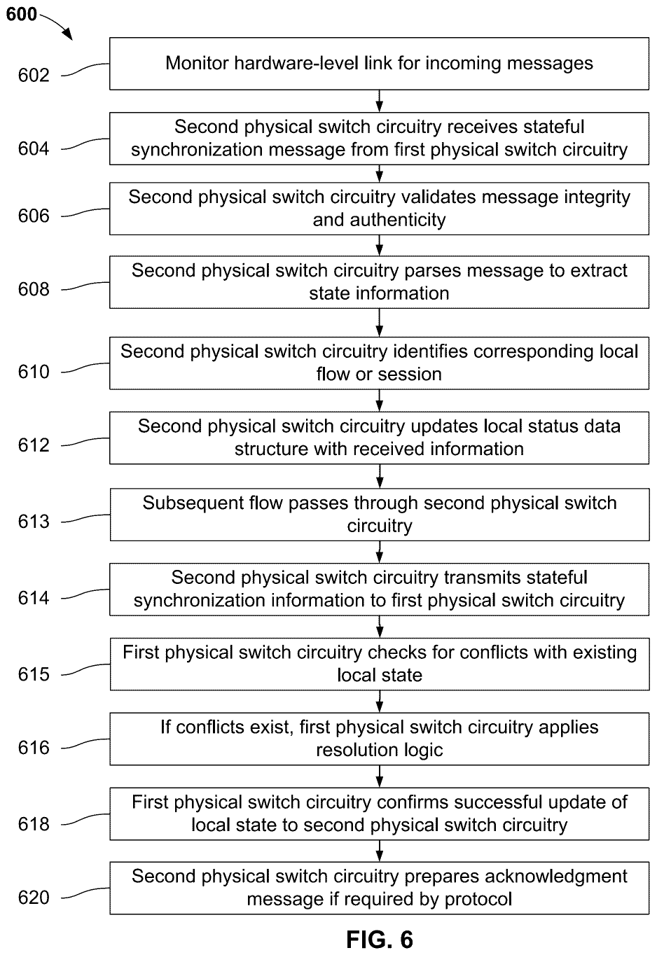

FIG. 6 illustrates an example stateful traffic tracking synchronization method 600, according to some implementations. The method 600 may monitor and synchronize hardware-level messages between the physical switch circuitries 108 and 110. The method 600 may include a sequence of operations for processing incoming synchronization messages, including validation, state updates, conflict resolution, and acknowledgment handling. The method 600 may use the components and methods introduced in earlier figures, such as the switches, communication links, and state information storage, while introducing new steps specific to the monitoring and synchronization process.

The method 600 begins at step 602, where the processor 122 and/or first and second stateful tracking instructions 454 and 464 (e.g., by using a hardware synchronization module, e.g., the first and second processors 284 and 294) monitor a hardware-level link for incoming messages between two chassis, which may correspond to the first physical switch circuitry 108 and second physical switch circuitry 110 from FIG. 1.

At step 604, the second physical switch circuitry 110 receives a stateful synchronization message the first physical switch circuitry 108, similar to the process described in step 410 of FIG. 4. The method 600 continues to step 606, where the message integrity and authenticity are validated by the second physical switch circuitry 110.

The method 600 then proceeds to step 608, where the incoming message is parsed, by the second physical switch circuitry 110, to extract state information. The step 608 may involve the processor 122 from FIG. 1 and/or second processors 294 from FIG. 2 analyzing the message contents.

At step 610, the second physical switch circuitry 110 identifies the corresponding local flow or session in the status data structure 300 introduced in FIG. 3. At step 612, the local status data structure 300 is updated with the received information. At step 613, a subsequent flow (e.g., from the server 210) passes through the second physical switch circuitry 110. At step 614, the second physical switch circuitry 110 transmits stateful synchronization information to the first physical switch circuitry 108.

The method 600 then moves to step 615, where the first physical switch circuitry 108 checks for conflicts with existing local state information. If conflicts are detected, the process continues to step 616, where resolution logic is applied to resolve any discrepancies. The step 616 may involve communication between the switch circuitries 108 and 110, similar to the process shown in FIG. 4 between first and second physical switch circuitries 108 and 110.

In some implementations, the method 600 then proceeds to step 618, where successful update at the first physical switch circuitry 108 of the local state is confirmed when the first physical switch circuitry 108 sends a confirmation message to the second physical switch circuitry 110. The step 618 may utilize the status data structure 300 (e.g., stored in the memory 126) from FIG. 1 to store the updated state information.

The method 600 proceeds to step 620, where an acknowledgment message is prepared by the second physical switch circuitry 110 if required by the protocol. The step 620 may involve sending a message back through the hardware-level link 116 shown in FIGS. 1 and 2.

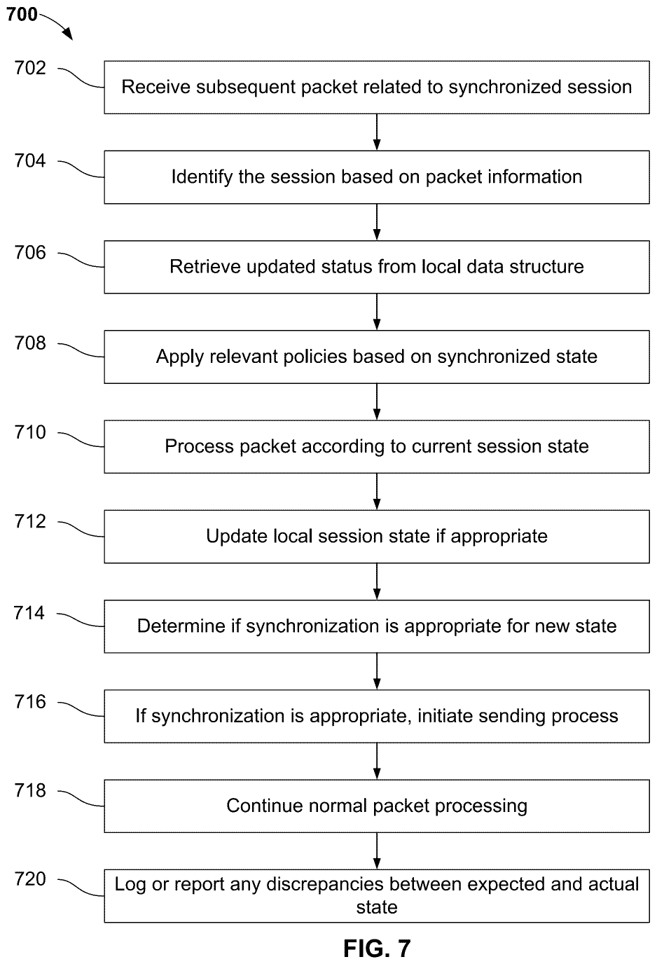

FIG. 7 illustrates an example stateful traffic tracking synchronization method 700, according to some implementations. The method 700 may process packets in a synchronized session environment. The method 700 begins with step 702, where a subsequent packet related to a synchronized session is received. As an example, the network interface or ingress port of the physical switch circuitry 110 may receive the subsequent packet. The step 702 may correspond to the process described in steps 414 through 419 of FIG. 4, where a return packet is routed through the witch circuitry 110.

The method 700 continues to step 704, where the second physical switch circuitry 110 identifies the session based on packet information. This step may utilize the processor 122 from FIG. 1 and/or the second processor 294 from FIG. 2 to analyze the packet contents. As an example, the stateful tracking instructions 464 of the switch circuitry 110 receiving the subsequent packet identifies the session.

At step 706, the second physical switch circuitry 110 retrieves updated status from a local data structure 300 introduced in FIG. 3. As an example, the second processor 294 of the switch circuitry 110 receiving the subsequent packet retrieves the updated status from the local status data structure 300.

The method 700 then moves to step 708, where relevant policies are applied based on the synchronized state. The step 708 may involve the processor 122 and/or the second processor 294 to apply relevant policies based on the synchronized state.

Following this, at step 710, the packet is processed according to the current session state, similar to the process described in step 419 of FIG. 4. At step 712, the local session state is updated if necessary based on the packet processing. The step 712 may utilize the memory 126 from FIG. 1 to store the updated state information.

The method 700 then proceeds to step 714, where the network switching system 104 determines if the new state requires synchronization. As an example, the second processor 294 in concert with the first processor 284 and/or the processor 122 may determine if the new state requires synchronization with the peer switch circuitry 108. The step 714 may be similar to the process described in steps 613 through 615 of FIG. 6.

If synchronization is needed, the method 700 moves to step 716, where a sending process is initiated. The step 716 may be similar to the process described in steps 422 and 424 of FIG. 4, where an update synchronization message is generated and sent through the hardware-level link 116. As an example, if synchronization is needed, the first or second processor 284 or 294, respectively, and/or the processor 122 may initiate the sending process, preparing a synchronization message.

The flowchart then continues to step 718, where normal packet processing continues. This step may involve forwarding the packet to its destination, similar to the process described in steps 418-419 of FIG. 4. As an example, a packet processing pipeline of the second switch circuitry 110 may continue normal packet processing, which may include forwarding the packet to its destination.

The method 700 proceeds to step 720, where any discrepancies between expected and actual state are logged or reported. As an example, the first or second processor 284 or 294, respectively, or a logging module within the first or second switch circuitry 108 or 110, respectively, and/or the processor 122 logs or reports any discrepancies between the expected state and the actual state.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts may operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. It is therefore intended that the appended claims encompass any such modifications or implementations.

What is claimed is:

1. A network switching system, comprising:
first switch circuitry;
second switch circuitry, the first switch circuitry being distinct from the second switch circuitry, the second switch circuitry having a status data structure;
a hardware-level link coupling the first switch circuitry and the second switch circuitry; and
a first processor associated with the first switch circuitry and configured to:
detect a new communication session at the first switch circuitry;
generate a stateful synchronization message that includes state information about the new communication session;
transmit the stateful synchronization message from the first switch circuitry to the second switch circuitry through the hardware-level link; and
update the status data structure at the second switch circuitry based on the stateful synchronization message received from the first switch circuitry.

2. The network switching system of claim 1, wherein the hardware-level link is a keepalive link.

3. The network switching system of claim 1, further comprising an inter-switch link (ISL) coupling the first switch circuitry and the second switch circuitry, wherein the ISL is separate from the hardware-level link and is configured to transmit data plane traffic between the first switch circuitry and the second switch circuitry.

4. The network switching system of claim 1, wherein the hardware-level link operates at layer 2 or layer 3 of an open systems interconnection (OSI) model.

5. The network switching system of claim 1, wherein the state information of the stateful synchronization message comprises at least one of a source internet protocol (IP) address, a destination IP address, a source transmission control protocol (TCP) port, a source user datagram protocol (UDP) port, a destination TCP port, a destination UDP port, an identifier of the new communication session, or a protocol state.

6. The network switching system of claim 1, wherein the network switching system further comprises a second processor associated with the second switch circuitry, the second processor configured to:
receive a subsequent packet related to the new communication session at the second switch circuitry;
determine that the subsequent packet relates to the new communication session based on the updated status data structure; and
process the subsequent packet based on the updated status data structure.

7. The network switching system of claim 1, wherein the first processor is further configured to prioritize transmission of a heartbeat message over transmission of the stateful synchronization message through the hardware-level link.

8. The network switching system of claim 1, wherein the first switch circuitry is in a first chassis and the second switch circuitry is in a second chassis, the first and second chassis being configured as a virtual switching extension (VSX) pair.

9. The network switching system of claim 1, wherein the first processor is further configured to:
detect a conflict between state information in the first switch circuitry and state information in the second switch circuitry; and
resolve the conflict by overwriting the state information in the second switch circuitry with the state information from the first switch circuitry.

10. The network switching system of claim 1, wherein the network switching system is configured to operate as a stateful firewall using state information synchronized between the first switch circuitry and the second switch circuitry.

11. A network device, comprising:
first switch circuitry configured to be coupled to second switch circuitry via a data plane communication link to transmit data plane traffic between the first switch circuitry and the second switch circuitry;
a processor configured to:
detect a new communication session at the first switch circuitry;
generate a stateful synchronization message that includes state information about the new communication session; and
transmit the stateful synchronization message from the first switch circuitry to the second switch circuitry through a hardware-level link via which the first switch circuitry is configured to be physically coupled to the second switch circuitry.

12. The network device of claim 11, wherein the hardware-level link is a keepalive link.

13. The network device of claim 11, further comprising an inter-switch link (ISL) coupling the first switch circuitry and the second switch circuitry, wherein the ISL is separate from the hardware-level link and is configured to transmit data plane traffic between the first switch circuitry and the second switch circuitry.

14. The network device of claim 11, wherein the hardware-level link operates at layer 2 or layer 3 of an open systems interconnection (OSI) model.

15. The network device of claim 11, wherein the network device further comprises:
a first processor associated with the first switch circuitry and configured to:
update a status data structure at the second switch circuitry based on the stateful synchronization message received from the first switch circuitry; and
a second processor associated with the second switch circuitry, the second processor configured to:
receive a subsequent packet related to the new communication session at the second switch circuitry;
determine that the subsequent packet relates to the new communication session based on the updated status data structure; and
process the subsequent packet based on the updated status data structure.

16. A computer-implemented method, comprising:
detecting a new communication session at a first switch circuitry;
generating a stateful synchronization message that includes state information about the new communication session;
transmitting the stateful synchronization message from the first switch circuitry to a second switch circuitry through a hardware-level link, wherein:
the first switch circuitry is distinct from the second switch circuitry;
the second switch circuitry has a status data structure; and
the hardware-level link couples the first switch circuitry and the second switch circuitry; and
updating the status data structure at the second switch circuitry based on the stateful synchronization message received from the first switch circuitry.

17. The computer-implemented method of claim 16, further comprising:
prioritizing transmission of a heartbeat message over transmission of stateful synchronization messages through the hardware-level link.

18. The computer-implemented method of claim 16, wherein the first switch circuitry is in a first chassis and the second switch circuitry is in a second chassis, the first and second chassis being configured as a virtual switching extension (VSX) pair.

19. The computer-implemented method of claim 16, further comprising:
detecting a conflict between state information in the first switch circuitry and state information in the second switch circuitry; and
resolving the conflict by overwriting the state information in the second switch circuitry with the state information from the first switch circuitry.

20. The computer-implemented method of claim 16, wherein the first switch circuitry and the second switch circuitry are configured to operate as a stateful firewall using state information synchronized between the first switch circuitry and the second switch circuitry.
